(19) United States
(12) Patent Application Publication
(10) Pub. No.: US 2014/0236776 A1
(43) Pub. Date: Aug. 21, 2014

(54) System and Method for Virtual Product Demonstrations

(71) Applicant: COVIDIEN LP, Mansfield, MA (US)

(72) Inventors: Timothy W. Fries, Louisville, CO (US); John A. Battista, JR., Lafayette, CO (US)

(73) Assignee: COVIDIEN LP, Mansfield, MA (US)

(21) Appl. No.: 13/770,770

(22) Filed: Feb. 19, 2013

(51) Int. Cl. G06Q 30/06

(52) U.S. Cl. CPC G06Q 30/0643
USPC 705/27.2

(57) ABSTRACT

A method and system are provided that virtually demonstrate the features of one or more products and allows users to interact with the one or more virtual products. In one embodiment, a product demonstration system may include a hand held device. The handheld device may include a display for displaying one or more products available from a supplier of the products. The handheld device may be configured to enable a user to simulate interaction with at least one product. The handheld device may also include a processor configured to receive a user input to manipulate at least one product of the products.

### BACKGROUND

The present disclosure relates generally to product demonstration and more particularly, to virtual demonstrations of products for sale.

This section is intended to introduce the reader to various aspects of art that may be related to various aspects of the present disclosure, which are described and/or claimed below. This discussion is believed to be helpful in providing the reader with background information to facilitate a better understanding of the various aspects of the present disclosure. Accordingly, it should be understood that these statements are to be read in this light, and not as admissions of prior art.

In many industries it is common practice to rely on traveling salespeople to market the product lines of manufacturers to customers. For example, it may not be practical for manufacturers of some types of highly specialized products, such as those who manufacture medical monitoring devices, to maintain retail storefronts. These products often do not need to be available to the general public and are instead marketed to a specific segment of geographically diverse customers. In these industries, as part of the typical sales cycle, salespeople may make visits to customer sites and attend trade shows to present their products to customers. Rather than rely on catalogs or other passive promotional material, it is preferable to demonstrate the use of the products and/or allow customers to interact with the product.

However, for various reasons, transporting products to various marketing sites may raise logistical problems. For example, products can be physically cumbersome: a product may be heavy, bulky, and include multiple separate components. Even if an individual product is easily portable, manufacturers often offer multiple types of products and multiple models for each type of product, each model including or omitting certain combinations of components or capabilities. Transportation of entire product lines may be desirable to better meet the varied requirements of diverse customers, but depending on the physical characteristics and extent of a manufacturer's product line this may be impossible or impractical. Additionally, some products may require certain resources to operate, such as external power, networking capability, and in the case of medical monitoring equipment, a patient. Salespeople cannot be sure that all the necessary resources will be available at the various marketing sites. There is therefore a need for self-contained systems that allow for the virtual interactive demonstration of products.

### BRIEF DESCRIPTION OF THE DRAWINGS

Advantages of the disclosed techniques may become apparent upon reading the following detailed description and upon reference to the drawings in which:

FIG. 1 is an illustration of a product demonstration system, in accordance with an embodiment;

FIG. 2 is an illustration of a product demonstration system, in accordance with an embodiment;

FIG. 3 is a block diagram of the product demonstration system of FIG. 1;

FIG. 4 is an illustration of a product menu screen, in accordance with an embodiment;

FIG. 5 is an illustration of a product detail and demonstration options screen, in accordance with an embodiment;

FIG. 6 is an illustration of a screen shot shown on the display of the product demonstration system of FIG. 1 that includes the front view of a product, in accordance with an embodiment;

FIG. 7 is an illustration of a screen shot shown on the display of the product demonstration system of FIG. 1 that includes the side view of a product, in accordance with an embodiment;

FIG. 8 is an illustration of a screen shot shown on the display of the product demonstration system of FIG. 1 that includes a view of the rear panel of a product, in accordance with an embodiment;

FIG. 9 is an illustration of a screen shot shown on the display of a product demonstration system that includes the simulated GUI of a product, in accordance with an embodiment;

FIGS. 10A-10I are illustrations of additional products that a product demonstration system may demonstrate, in accordance with an embodiment;

FIG. 11 is a flow diagram of a method for operating a product demonstration system, in accordance with an embodiment;

FIG. 12 is a flow diagram of an additional method for operating a product demonstration system, in accordance with an embodiment; and

FIGS. 13A-13D are illustrations of a method for operating the product demonstration system, in accordance with an embodiment.

### DETAILED DESCRIPTION OF SPECIFIC EMBODIMENTS

One or more specific embodiments of the present techniques will be described below. In an effort to provide a concise description of these embodiments, not all features of an actual implementation are described in the specification. It should be appreciated that in the development of any such actual implementation, as in any engineering or design project, numerous implementation-specific decisions must be made to achieve the developers' specific goals, such as compliance with system-related and business-related constraints, which may vary from one implementation to another. Moreover, it should be appreciated that such a development effort might be complex and time consuming, but would nevertheless be a routine undertaking of design, fabrication, and manufacture for those of ordinary skill having the benefit of this disclosure.

As noted above, the capability to perform virtual product demonstrations may greatly assist salespeople marketing certain products. Products that are bulky, perform complex data processing, employ varied sensors, and/or employ multilayered user interfaces, such as medical monitoring devices, may be prime candidates for a combination of simulated and actual demonstration. Thus, the disclosed embodiments provide systems for providing product demonstration and methods for interacting with product demonstration systems. To provide for the desired portability, the system may include a portable handheld device. In particular, the main body of a medical monitoring device may be simulated using a handheld device in communication (e.g., via a wired or wireless interface) with an external processing module for processing physiological signals and sensor for obtaining physiological signals. The handheld device may be configured to enable a user to simulate interaction with the at least one product. The handheld device may include a display for displaying one or more products available from a supplier of the products. The handheld device may also include processor configured to receive a user input to manipulate at least one product of the products. The display may include a touchscreen configured to receive the user input. The handheld device may include a smart phone, a tablet computer, or laptop.

Static images, or even dynamic video, may not allow a salesperson to adequately exhibit the advantageous physical characteristics of a product. For example, it may be useful to have the ability to view a product from various perspectives such as from the sides, the back, above, or below. Further, it may be valuable to allow the potential customer to modify the perspective of the product as it is being viewed in order to reveal or highlight a specific desired feature or view the overall physical layout of the product. Accordingly, in certain embodiments, the product demonstration system may allow user input to manipulate a view of the product. At the same time, the display may be configured to alter the view of the product in response to the user input. A product being marketed to a customer may have multiple components, such as attachments, removable and replaceable cartridges, button, knobs, and touchscreens. During a sales presentation, it may be advantageous to allow a potential customer to interact with these components. Thus, the product demonstration system may allow user input to manipulate physical components of the product while the display is configured to display the manipulation of the physical component.

In certain embodiments, where the product being demonstrated is a medical device, such as a medical monitoring device, it may be beneficial to demonstrate the manner in which the product displays physiological data. Therefore, the product demonstration system may receive user input requesting acquiring physiological data, as the display is configured to display the physiological data. The physiological data may be actual detected physiological data or may be simulated physiological data. The use of simulated data will avoid the need to properly attach a working sensor and may allow the simulation of certain physiological conditions to show the response of the product to certain special situations or abnormalities. In certain cases, the processor of a handheld device may not simulate all of the processing desired to adequately demonstrate the features of a product to a potential user. For example, it may be beneficial for a salesperson to demonstrate some complex signal processing that the product can accomplish that the processor of the handheld device is unable to simulate. Accordingly, the product demonstration system may include a processing module separate from the handheld device, communicatively coupled to the handheld device.

Furthermore, in certain embodiments, the external processing module may be configured to provide physiological data to the handheld device upon receiving a request from the handheld device based on the user input the handheld device may receive. The external processing module may be communicatively coupled with the handheld device in order to receive user input from and communicate display instructions to the handheld device. This connection may be made via a wireless interface. Alternatively or additionally, this connection may be made with a wired interface. The product demonstration system may include a sensor operatively coupled to the processing module and configured to acquire a signal representative of physiological data. The processing module may be configured to process the signal and to provide actual physiological data. The physiological data may be acquired from a user of the demonstration system via the sensor and sent to the handheld device. At the same time the display may configured to display the actual physiological data. The sensor may include a pulse oximetry sensor. The product demonstration system may demonstrate products including monitoring devices, sensors, accessories, or a combination thereof.

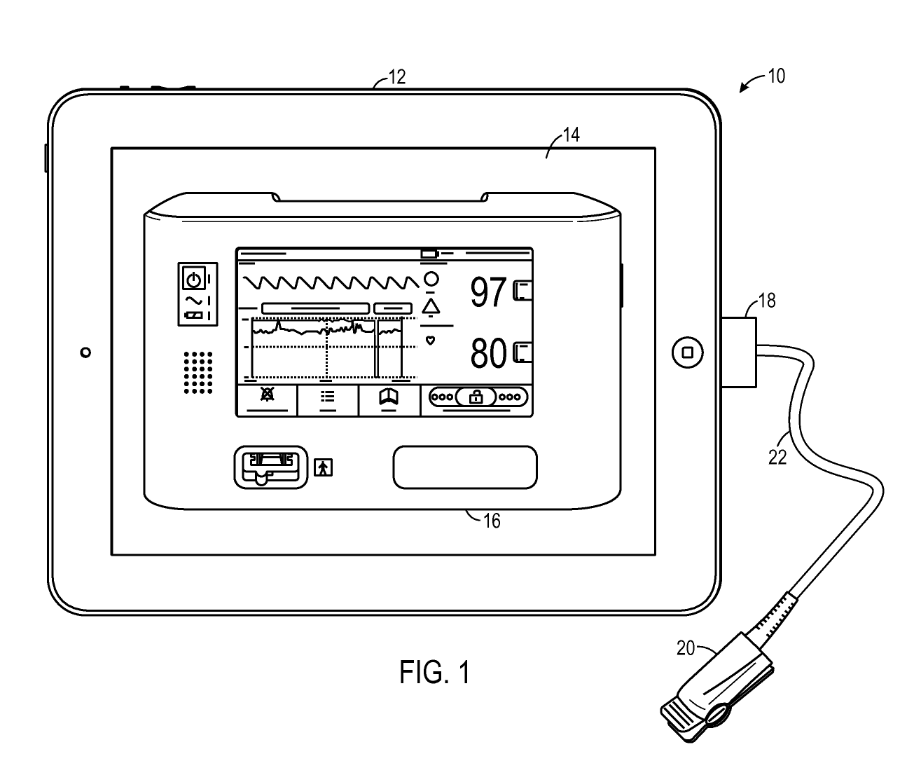

With the foregoing in mind, FIG. 1 is an illustration of a product demonstration system 10, in accordance with an illustrative embodiment. The system 10 includes a handheld device 12 that includes a display 14 that may also include a user input device (i.e., touchscreen). The handheld device may include a tablet computer, a laptop, a smart phone, or any other suitable portable electronic device. The display 14 is depicted showing an interactive rendering 16 of a product (e.g., a medical monitor such as a pulse oximeter). The display will allow the user to view the features of the monitor, as well as interact with the product rendering. Hence, the display may be of an appropriate dimension and adequate resolution to sufficiently display multiple product features. For example, in some embodiments the display may have an aspect ratio of 16:9, a diagonal dimension in the range of 15 cm to 30 cm and a resolution of 1280×720 or greater. The interactive rendering 16 may include the monitor of a medical monitoring device, or any other product that may be suitable to be simulated on the product demonstration system 10 such as computers, appliances, automation equipment, or other complex devices. Also included in the system 10 may be an external processing module 18 coupled to the handheld device 12. The external processing module 18 may be included in order to simulate advanced processing that the handheld device 12 may not adequately simulate on its own. In some embodiments, the handheld device may be able to simulate all the necessary functions of a product without an external processing module 18. In other embodiment, where an external processing module 18 is present, it may also be coupled to an optional sensor 20 via a cable 22. The sensor 20 may be one of many sensors that the product being demonstrated may employ. The handheld device 12 may be easily portable and mobile and may operate without external power (e.g., via battery). The product demonstration system 10 may be compact and self-contained; therefore a traveling salesperson may comfortably transport the entire system 10 to marketing sites and operate it without external resources, if necessary. The interactive product rendering 16 illustrates the physical characteristics of the actual product, and has interactive features that enable a potential customer to virtually use the product. Using the system 10 a salesperson may demonstrate the desirable and useful features of the one or more products without the presence of the actual product or products. The features of the interactive product rendering 16 that enable this demonstration are discussed more fully below.

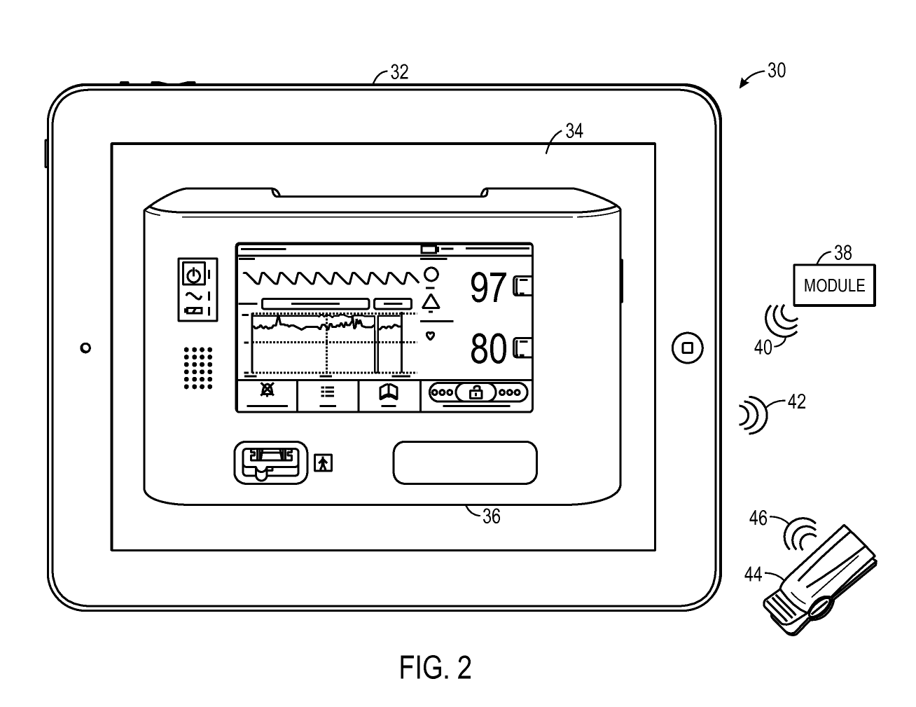

An embodiment of the product demonstration system, in which some physical connections are omitted and wireless technology is alternatively used, is illustrated in FIG. 2. Similar to the previously discussed embodiment, the system 30 depicted includes a handheld device 32 that includes a display 34 that may be a touchscreen. The handheld device 32 depicted is a tablet computer, but as in the previous embodiment, the handheld device 32 may also include a laptop, a smart phone, or any other suitable device. The illustrated display 34 is shown displaying an interactive rendering 36 of a product being demonstrated. As shown, the rendering 36 of the product being demonstrated may include the monitor of a medical monitoring device, or any other product that may be suitable to be simulated on the product demonstration system, as discussed above. Also, the system 30 may include an external processing module 38. In this embodiment, the coupled external processing module 38 is coupled to the handheld device 32 via respective wireless interfaces 40, 42. The external processing module 38 illustrated is also coupled to an optional sensor 44 via a wireless interface 46. The product demonstration system 30 is compact and self-contained, and as discussed above, because some embodiments do not include a sensor 44 or an external processing module 38, the entire product demonstration system 30 may be contained on the handheld device 32. Therefore, a traveling salesperson may comfortably transport the entire system 30 to marketing sites and operate it without external resources, if necessary. The interactive product rendering 36 illustrates the physical characteristics of the actual product, and has interactive features that enable a potential customer to virtually use the product on the handheld device 32. By use of the system 30 a salesperson may demonstrate the desirable and useful features of the product without the presence of the actual product and also free from wired connections of components to the handheld device 32.

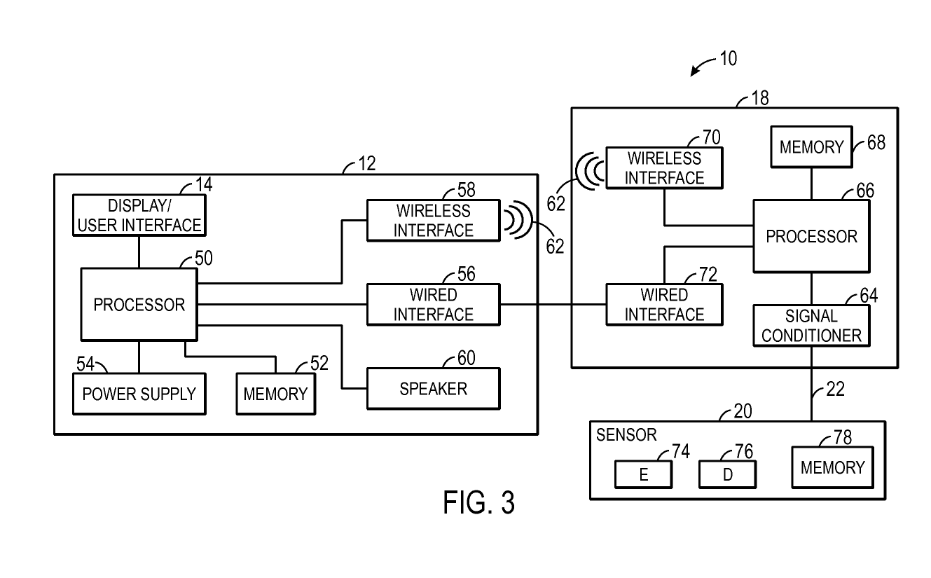

To further illustrate details of an embodiment of the product demonstration system, FIG. 3 is a block diagram of the product demonstration system of FIG. 1. As discussed above, the system 10 includes a handheld device 12 that includes a display 14 that may also include a user input device. The display 14 and user input device may be integrated, such as in a touchscreen. Alternatively or additionally, the handheld device 12 may utilize external input devices such as a keyboard and mouse. The handheld device 12 also includes a processor 50, memory 52, power supply 54, wireless interface 56, wired interface 58, and a speaker 60. The wired interface 58 may include a USB interface (e.g., versions 1.0, 2.0, or 3.0), IEEE 1394, or any other suitable wired communication interface. The processor 50 is linked to each of the display 14, wireless interface 58, wired interface 56, the power supply 54, and speaker 60. The memory 52 of the handheld device 12 may store instructions for utilizing the demonstration software. The wireless interface 58 may send and receive wireless transmissions 62 using a variety of wireless technologies such as WiFi, Bluetooth, NFC, RFID or any other suitable wireless technology. The handheld device 12 may be communicatively coupled to an external processing module 18 via the wired interface 56 and/or the wireless interface 58.

The external processing module 18 may contain a signal conditioning module 64, a processor 66, memory 68, wireless interface 70, and wired interface 72. In some embodiments, the internal components of the external processing module 18 may include an original equipment manufacturer (OEM) pulse oximetry module. The pulse oximetry module may calibrate a sensor, reduce noise in signals received from a sensor, extract signals representing arterial signals, and process these signals into physiological information such as pulse rate and peripheral oxygen saturation (SpO₂). In other embodiments, the OEM pulse oximetry module may be supplemented with additional hardware. As with the interfaces discussed above, the wireless interface 70 and wired interface 72 of the external processing module 18 may utilize any suitable communications technologies. The external processing module 18 is coupled to a sensor 20 via cable 22. The sensor 20 includes an emitter 74 (e.g., an LED) and detector 76 as well as memory 78. The memory 68 on the sensor 20 may store information about the sensor 20 which the external processing module 18 uses to simulate operation of a product, including the sensor's calibration data, model type, troubleshooting codes, and error detection data. The signal conditioner 64 receives signals from the sensor 20 and may do initial conditioning such as multiplexing, pre-amplification, and converting the analog signal to a digital form. The conditioned signal is then sent to the processor 66 on the external processing module 18. The processor 66 simulates various signal processing algorithms. Examples of algorithms the processor 66 may employ are those that calculate arterial blood oxygen saturation, and algorithms that determine the pulse rate. The sensor memory 78 may store code or instructions to implement the signal processing algorithms and also may store sensor calibration information. In other embodiments, the memory 78 may also store simulated or sample data. This simulated data may be used when no patient data is available or when the processor 66 of the external processing module 18 does not have the capability to do adequate processing to mimic certain functions of the product being simulated. In these systems, the external processing module 18 may not receive any data from the sensor 20, and therefore may not utilize a signal conditioning module 64.

In some embodiments, the signal conditioning hardware may be located on the sensor 20, and a signal is then preconditioned before being sent via the wired connection 22 to the external processing module. Additionally or alternatively, some of the memory 78 hardware may be located on the sensor 20. In other embodiments, the hardware of the external processing module 18 may be located on the sensor 20, so that the handheld device 12 may be linked directly to the sensor 20. In addition to demonstrating the monitoring device depicted in the interactive product rendering 16, the product demonstration system 10 is capable of demonstrating the interaction of the monitoring device with the various sensors available. For example, a monitoring device may display different messages or allow different options in response to being linked to different sensors. Additionally, the system 10 may be capable of demonstrating the different capabilities of the various sensor products available. For example, various sensors may be offered that allow different methods of attachment to a patient. The demonstration system 10 may be used to demonstrate the proper attachment of a sensor to a patient, and the system dialogs that may appear related to attachment of a sensor. For example, the system 10 may post an alarm upon the loss of a pulse signal that was previously detected or upon a sensor off condition.

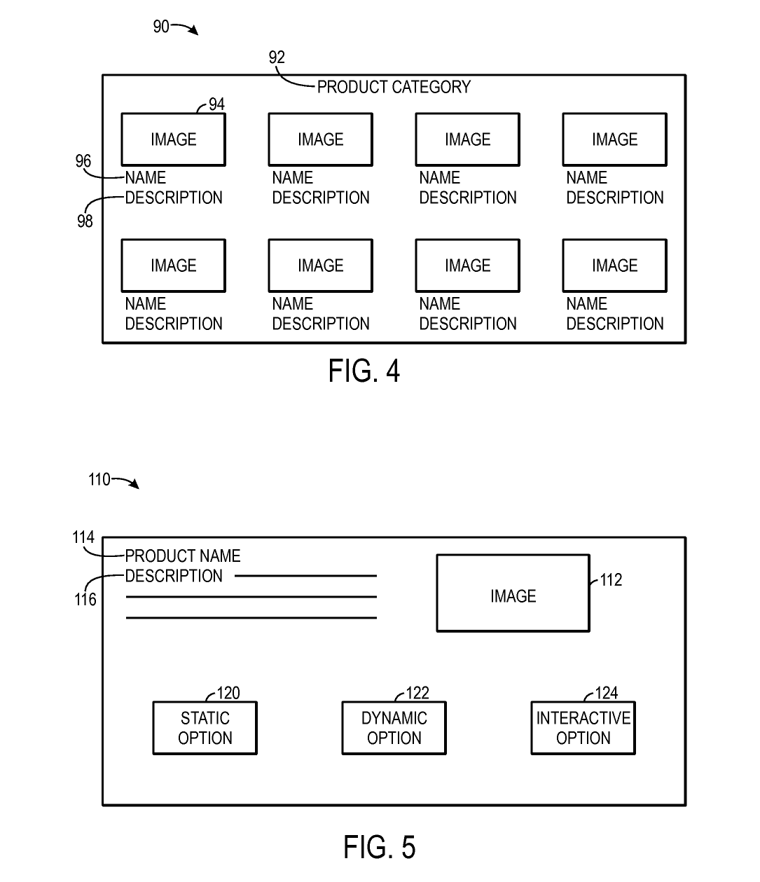

On commencing operation of the product demonstration system 10, a product menu screen 90 may initially displayed on the handheld device 12, as illustrated by FIG. 4. The product menu screen 90 may include a menu title 92 describing the scope of the menu (e.g., the various products available for virtual demonstration). It is contemplated that multiple levels of menus and submenus encompassing various scopes of organization may used in order to navigate a line of products. These submenus should enhance navigability of the system when a large number of products are being represented. For example, a first menu may show the various high level product divisions of a manufacturer, a submenu may show a broad category of products available within each division, and the last submenu may show the individual product models within each broad category. Each product (or category of products) available on the menu screen 90 may have a representative image 94, name 96, and description 98. The design of the menu contents may be such that the terminal menu contains a limited number of products, so that each product may have adequate space on the screen to contain an image 94 name 96 and description 98. Additionally, the menu screen 90 may include multiple representative images 94 for each product. Alternatively, product images 94 may be entirely omitted and replaced with descriptive text. Products may be displayed in linear arrangement such as a list or table. The list or table may be organized in a hierarchical fashion such as in the form of an outline. The display of products may be static, or dynamic (e.g., including categories or descriptions that expand when selected). Adequate space may be provided so that the text of the name 96 and description 98 can be maintained at a readable size, while also leaving enough white space 100 for readability. The handheld device 12 may receive user input by detecting user interaction with (e.g., selection on the touchscreen by making brief contact) the product images 94, or the text accompanying the images, such as the product names 96 or descriptions 98.

Upon selection of a product, a product detail screen 110 may be shown such as illustrated in FIG. 5. The product detail screen 110 may include a representative image 112, a product name 114, and a product description 116. Additional features 118 of the product may also be featured on the product detail screen 110. The product detail screen 110 may allow users to choose from three options: a static option 120, a dynamic option 122, and an interactive option 124. The static option 120 brings the user to screens that show static images and text describing the features and specifications of the product, similar to what can be seen on a web page or brochure. The dynamic option 122 may include static images and text, but also includes video with accompanying audio. The videos may show perspective views of the product with features described in an audio track, or may include a demonstration of the use of the product. The interactive option 124 may include static images and text as well as video and audio, like the static 120 and dynamic 122 options, but also includes additional interactive features. The interactive features may include rendering of displays, buttons, knobs, data ports, and functional modules that may be manipulated by user input the handheld device 12 receives. These interactive features, among others, are described in greater detail below.

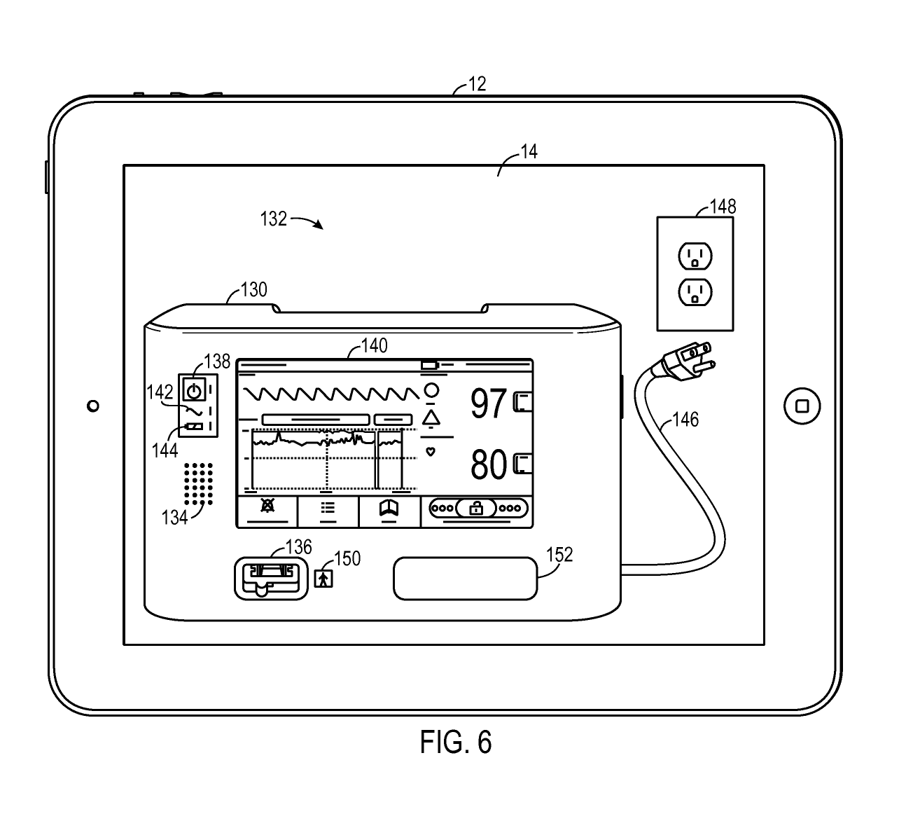

When the interactive option is selected, the touchscreen 14 of the product demonstration system 10 may initially display a view a front view of an interactive product rendering 16 as illustrated by FIG. 6. The details of the rendering 16 allow the user to view the physical layout of the front view of the monitoring device 130. The user may observe the relative sizes and locations of the different buttons (e.g., keys) and components of the monitor, such as the prominent locations of a speaker 134 and sensor port 136. In certain embodiments the product being simulated may include a single display, but in other embodiments there may be multiple displays. The one or more displays may be adaptable and interchangeably display graphics, text, and physiological values, or the one or more displays may each be dedicated to one or two purposes. For example, there may be a device that includes three displays in which one is dedicated to displaying a waveform, and two are dedicated to displaying physiological data. In certain embodiments, the monitoring devices may include one main body or hardware component, but in others there may be multiple hardware components.

The user may interact with renderings of the physical controls on the product, such as the virtual power on key 138, and the simulated graphical user interface (GUI) 140. The user, using the standard operation of the user interface of the handheld device 12, can simulate interaction with any buttons or keys on the virtual product, such as the pressing of the power on 138 key. In the present embodiment, a touch screen user interface is employed. Thus, the user may interact directly with the displayed image. In other embodiments, the user may use input devices such as a keyboard or mouse to act indirectly with the product rendering 16. Operation of the touch screen user interface may include placing the finger or stylus on the touch screen at the location of the displayed element and using different behaviors to simulate various actions, such as varying the amount of pressure used, the duration of the contact, the number of points of contact (e.g., using more than one finger), and making various movements or gestures, among other behaviors. Interaction with various components of the simulated product 130 may trigger feedback from the product demonstration system 10 to indicate to the user that interaction has been detected by the system 10. For example, the system speaker 60 may emit a clicking sound when a simulated button or key is selected, indicating that the button has been virtually pressed, and an animation showing movement of the button or key may be displayed on the hand held device display 14. Other appropriate auditory or visual feedback may be implemented by the demonstration system 10 to indicate that the user has interacted with virtual components of the product being demonstrated. Further details of user interaction with the simulated GUI and other elements of the products are discussed in greater detail below.

The product demonstration system 10 may additionally simulate certain important safety features of the product being demonstrated. For example, some products perform power-on self test (POST). To simulate this feature, immediately after the interactive product rendering 16 is powered up, all the pixels of the virtual GUI 140 may light, and the speaker 134 may sound three ascending tones. This process may demonstrate the behavior of the product and the ability of users in a clinical setting to verify, on each occasion of start-up, the working condition of all the pixels on the product screen as well as the working condition of the product speaker 134.

Users may also observe the presence, location, prominence, and functions of other elements of the virtual product rendering 16 such as the AC indicator 142 and the battery condition indicator 144. The AC indicator 142 in the product being displayed in the present embodiments is located adjacent to the power on key 138 and indicates when the monitor is connected to an alternating current power source. The battery condition indicator 144 is also located near the power on key 138 and AC indicator 142 and becomes lit when the virtual battery of the monitor is charging. The interactive product rendering 16 may include an interactive rendering of a power cord 146 and an AC electrical power outlet 148. In certain embodiments, the user may interact with the virtual power cord 146 and connect the virtual monitoring device 130 to the virtual power outlet 148 to observe the behavior of the monitoring device 130 and its various indicators in response to being on AC power or using battery power. Additionally, the battery status warnings, alarms, and functions such as automatic shutdown and power off of the product may also be simulated.

Because the interactive product rendering 16 may include all of the same external features as the actual product, the user may also observe the various labels and markers that are located on the actual product, such as the symbol 150 near the sensor port 136. This particular symbol has indicates that the sensor is a type that may have conductive contact with the patient for a medium to long term. This is a clinically significant indicator that may be of interest to a potential user. Other significant symbols may indicate that a product may have some environmental limitations such as atmospheric pressure, humidity or temperature limitations, or other cautions attached to its usage.

In some embodiments, the product demonstration system 10 may simulate the behavior of the monitoring device 130 in response to a sensor 20 being attached. When the sensor 20 is connected to the product demonstration system 10, an animation may be triggered that illustrates a virtual sensor being attached to the sensor port 136 on the rendering 16 of the product. In some embodiments, the connection of the sensor 20 to the system 10 is achieved by linking the sensor 20 to the external processing module 18 (e.g., via a wired or wireless link), which is in turn linked to the handheld device 12. In other embodiments, in which the external processing module 18 elements are located on the sensor 20 or where there is no external processing module 18, attaching the sensor directly to the handheld device 12 may achieve this link. As discussed above, memory 78 on the sensor contains information about the sensor such as model number and calibration information. When the demonstration system 10 is in operation, the external processing module processor 66 reads the sensor 20 information and sends the sensor model number to be displayed on the simulated monitoring GUI 140. The simulated monitoring device 16 may display a temporary “sensor attached” message, identifying the type of sensor 20 connected to the system. This simulated process may take a few seconds. The sensor model number disappears after the monitoring device rendering 16 starts to simulate tracking the patient's physiological parameters, such as their SpO₂ and pulse rate. In some embodiments, the external processing module processor 66 may actually identify the sensor 20. In other embodiments, the message may be only a simulation of the sensor identification function. The rendering 16 may simulate the behavior of the monitoring device 130 in response to a sensor 20 being attached, and any period while no valid physiological patient parameters are being detected, and then show the change in mode when a patient is properly attached to the sensor 20.

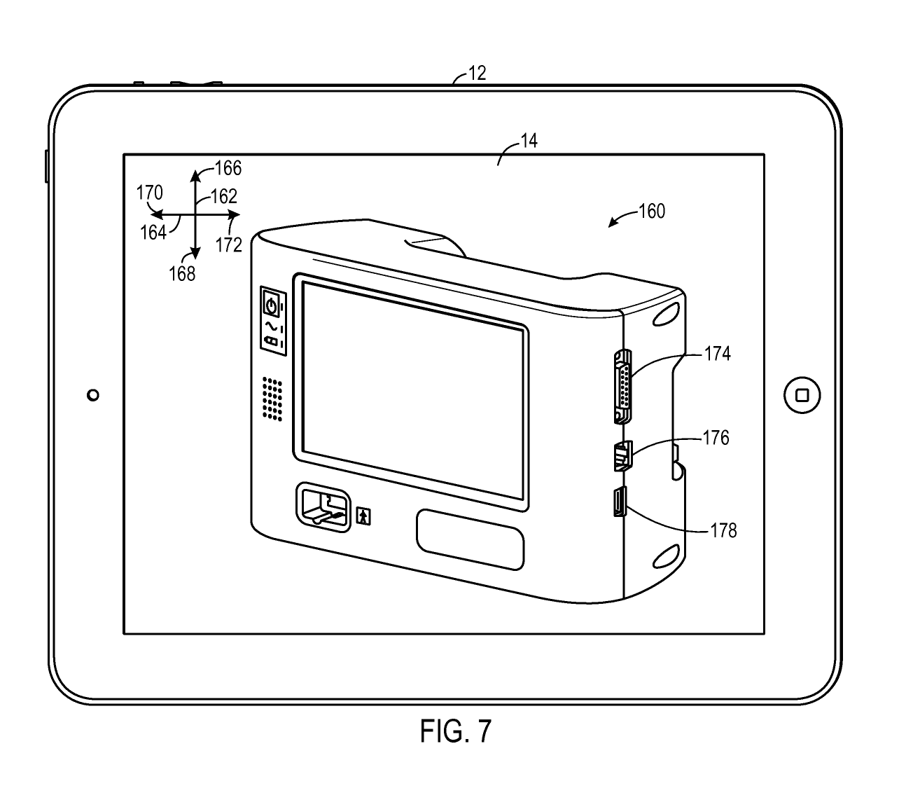

The user may interact with the rendering of the monitoring device 130 and rotate the rendering 16 to change the perspective of the view shown. For example, the user may rotate the rendering 16 about a vertical axis 162. In some embodiments, for products that may have features of interest on the top and bottom sides, the user may rotate the product around a horizontal axis 164. The user may alter the displayed perspective of the rendering 16 in other ways such as zooming in on (e.g., making larger) desired areas to view details of the product, and by panning up or down along the vertical axis 162 or right or left along the horizontal axes 164, or in any other direction. Accordingly, FIG. 7 is an illustration of a screen shot shown on the display 14 of the product demonstration system 10 as it is displaying a side view 160 of a monitoring device 130. This side view 160 reveals a serial data port 174, ethernet port 176, and a USB connector 178. The demonstration system 10 may provide renderings of additional equipment that can be linked to these ports and which the user may interact with, such as nurse call transmitters, network cables, external user input devices, or data storage devices. Additionally or alternatively, the demonstration system 10 may provide a pop-up dialog box containing a written description of the feature providing additional information about certain features of the product. The user may trigger this dialog box, when the user interacts with an element of the product rendering 16 via the user interface 14. For example, by selecting the product rendering 16 at the appropriate location on the display/touchscreen 14 a user may trigger additional information about the capabilities of the data port 174.

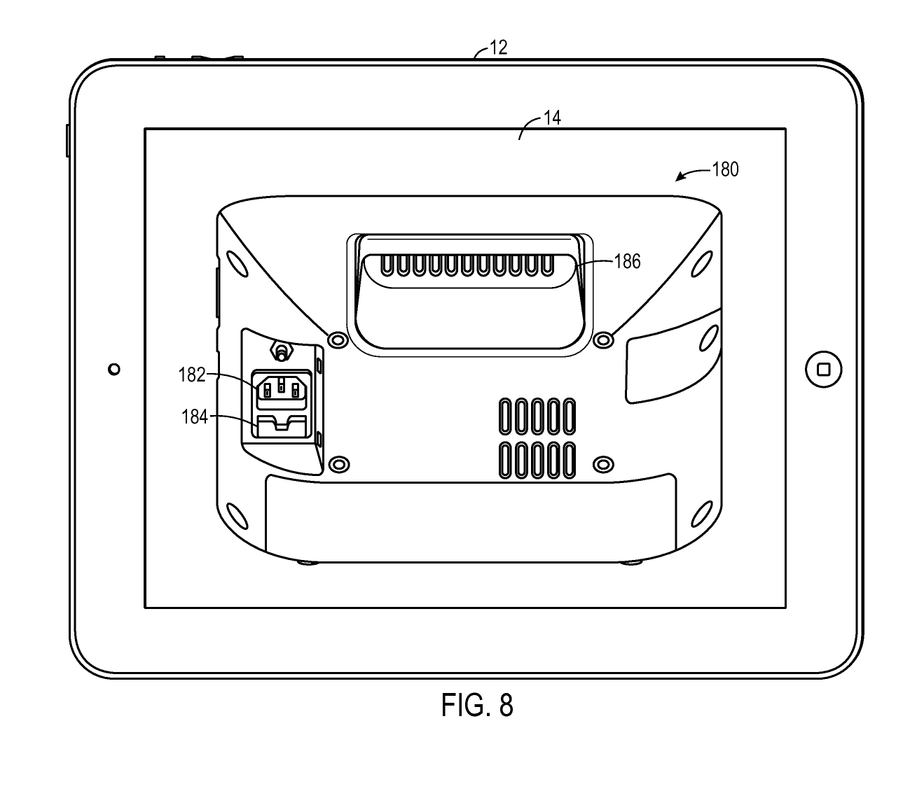

If the user manipulates the side view 160 of the product rendering 16 to rotate it about a vertical axis 162, the rear panel 180 of the product may be shown, as illustrated in FIG. 8. As discussed above, the user may manipulate the product rendering 16 about a vertical axis 162 and/or a horizontal axis 164 in order to view the product from various perspectives. The rendering of the rear panel 180 contains simulated features of a product that may be of interest to a potential customer such as the AC power connector 182, the fuse box 182, and the carrying handle 186. The rear panel view 180 may also allow the user to interact with a virtual power cord 146 and AC power outlet 148 as described above in regards to the features of the front panel illustrated in FIG. 6. In some embodiments, the rendering 16 will allow user to simulate removal of the rear panel 180 to, and may allow the user to virtually view the inner components of the product. This capability may allow a salesperson to describe the ease of maintenance and repair of the product. For example, the rendering may allow demonstration of the replacement of a product battery.

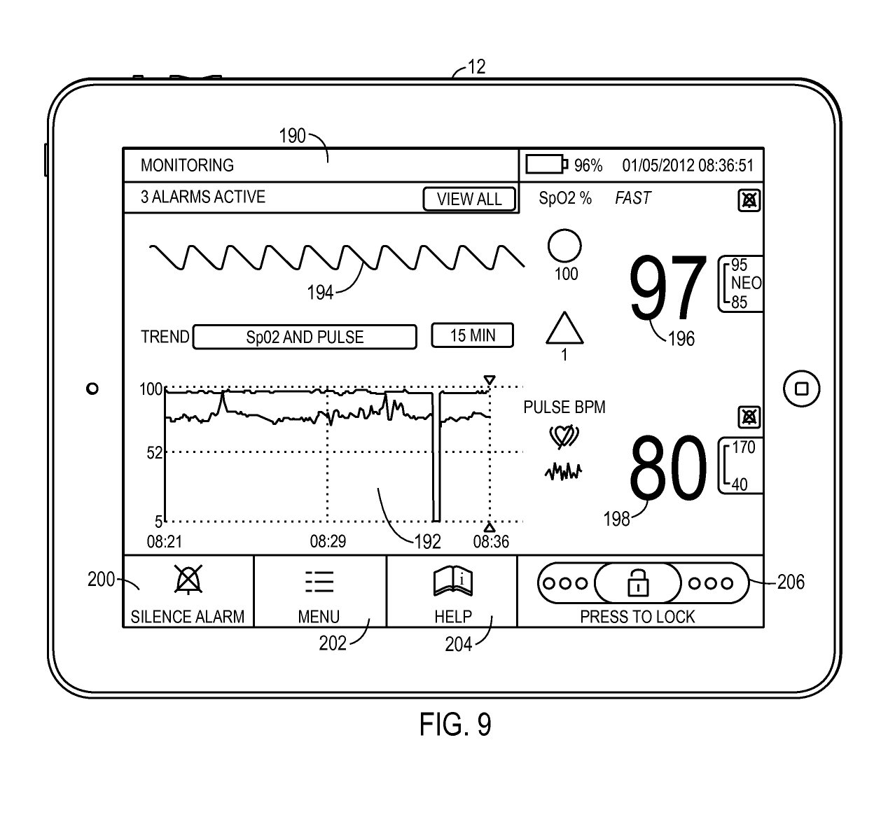

As discussed above, a user may manipulate the interactive product rendering 16 using the handheld device display 14, such as by zooming in on or panning across to view or interact with details of interest. Accordingly, FIG. 9 is an illustration of a screen shot of a front panel view 132 of the product rendering 16 focused on the simulated GUI 140. From this perspective the user may interact with the detailed features of the virtual GUI 140 of the simulated monitoring device 130. Illustrated is a virtual representation of a product's default monitoring screen 190 displaying physiological patient parameters. This may include two visualizations, a graph 192 and a waveform 194, and two patient parameter values, SpO₂ 196 and pulse rate 198. Also rendered prominently on the simulated default monitoring screen 190 are the silence alarm icon 200, the menu icon 202, the help information icon 204, and lock bar icon 206. The virtual GUI 140 is where a majority of the product's 130 features are shown. The salesperson will have the capability to exhibit the functions behind all the screen elements.

For example, the salesperson may initially demonstrate the options available in the simulated product's various menus. For example, the user may select the menu icon 204 of the virtual GUI 140, interacting with the virtual menus. By selecting this icon 204 the user may view the product's 130 available display settings, sound settings, and the various alarm settings. For example, the user may confirm that the backlight of the product may be dimmed and the screen on the virtual product rendering will also dim. Additionally, it may be demonstrated that the backlight returns during various clinically important conditions, such as when the user is interacting with the virtual GUI 140, or when an alarm is triggered. Further, the user may view the various operating modes available. For example, a monitoring device 130 may have an adult alarm mode and a neonatal alarm mode. The product demonstration system 10 may simulate all these functions. Additionally, the user may use the virtual graphical user interface 140 to navigate to the simulated monitoring settings menu and observe the ease of choosing the various modes of operation.

As discussed above with respect to FIG. 3, in some illustrative embodiments, the physiological patient parameter data may be transmitted to the handheld device 12 from the external processing module 18. The data may be the result of signals the sensor 20 detects and the and the external processing module 18 processes in real-time so that the physiological data displayed on the virtual monitor is substantially contemporaneous with the corresponding signal acquired from the sensor. In other embodiments, where suitable patient data may be unavailable, the data may alternatively be the result of sample data the external processing module 18 simulates. The handheld device 12 receives the actual or simulated patient data from the external processing module and displays it on the rendering 16 of the monitoring product 130. The simulated default monitoring screen 190 displays both a plethysmographic waveform 194 (pleth wave) and a graph of trend data 192. The view also displays two parameter values, SpO₂ 196 and the pulse rate 198. The user may utilize simulated menu options to change the monitoring layout and observe the various layout options. For example, the product being demonstrated in the present embodiment allows for the options of pleth wave and trend view, pleth wave only, trend view only, and a values only view, among others. Thus, the potential customer may interact with the product rendering 16 and observe the ability of the monitoring device 130 to switch views. The simulation of this feature may allow a salesperson to demonstrate how a product may be configured to better accommodate different clinical users, locations, or situations. For example, certain medical support staff may prefer a view that includes only real-time data and waveforms and omits historical trend data, while other medical professionals may prefer a view that includes trend data.

The demonstration system 10 may also simulate the various advanced alarm management techniques the monitoring product 130 being demonstrated employs, such as a delayed pulse rate alarm. In the actual product, the pleth wave may be used to calculate pulse rate. Pulse rate alarms are traditionally triggered when a pulse rate nears either an upper or lower alarm limit. To avoid nuisance alarms, the product 130 may require that there be a clinically significant, prolonged period of exceeding the threshold before an alarm is triggered. The user may use the demonstration system 10 to select the simulated menu option on the virtual GUI 140, virtually accessing and configuring the parameters of this feature, among others.

Only a few of all the features of a monitoring device that may be simulated on the demonstration system 10 have been discussed. The demonstration system 10 may replicate or simulate virtually all of the features of the product being demonstrated. As discussed above, there may be some functions that require advanced signal manipulation by advanced processing hardware, or additional power, or some other resource that the demonstration system 10 cannot provide. Therefore, the demonstration system 10 cannot perform all the functions of the actual product. But, where the actual behavior of the monitoring device product cannot be replicated, simulated data may be stored on the memory 68 of the external processing module 38 and used to imitate the behavior of the monitoring device 130 being demonstrated.

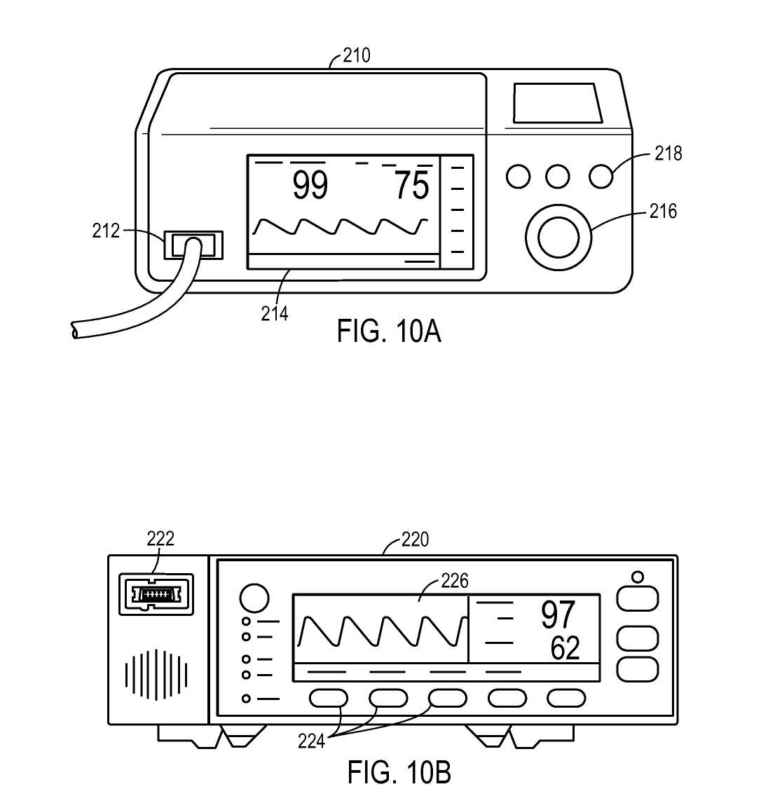

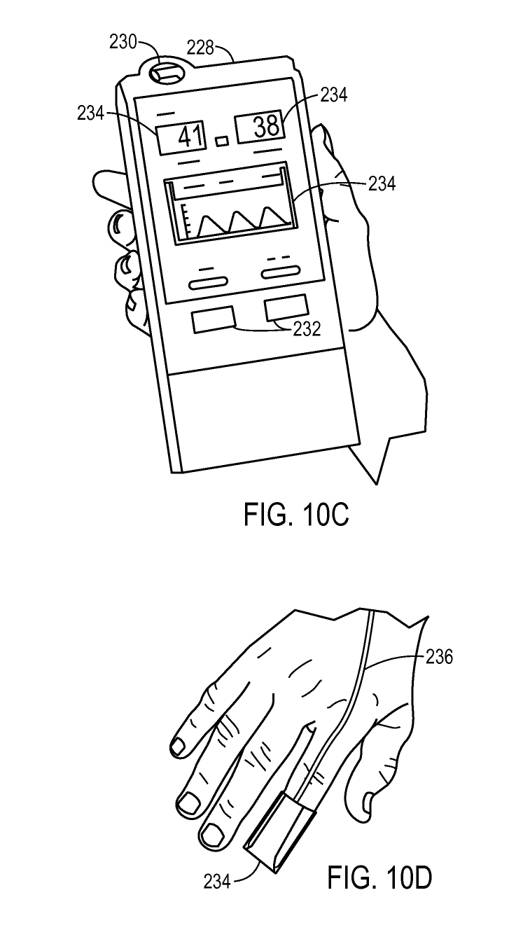

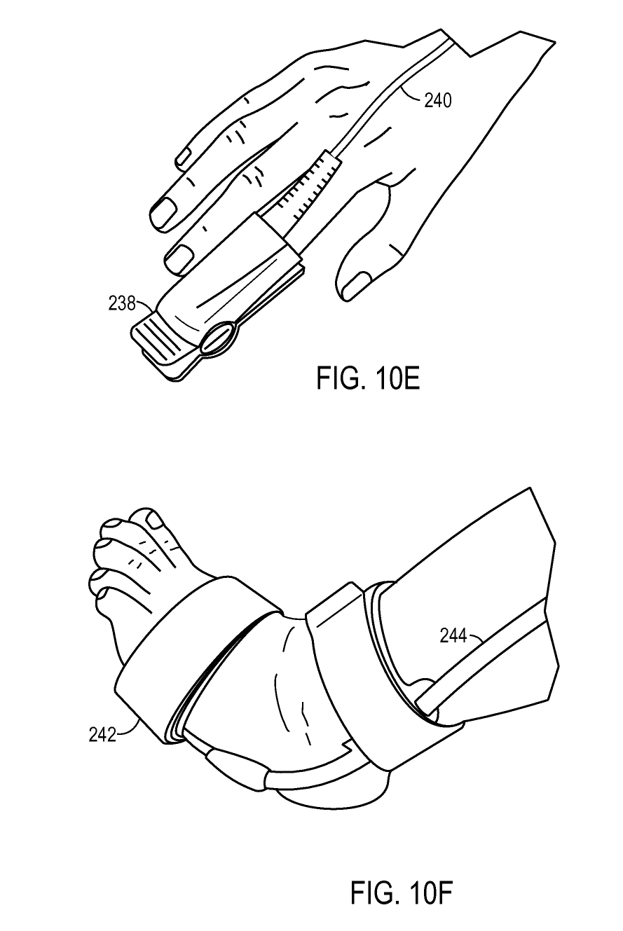

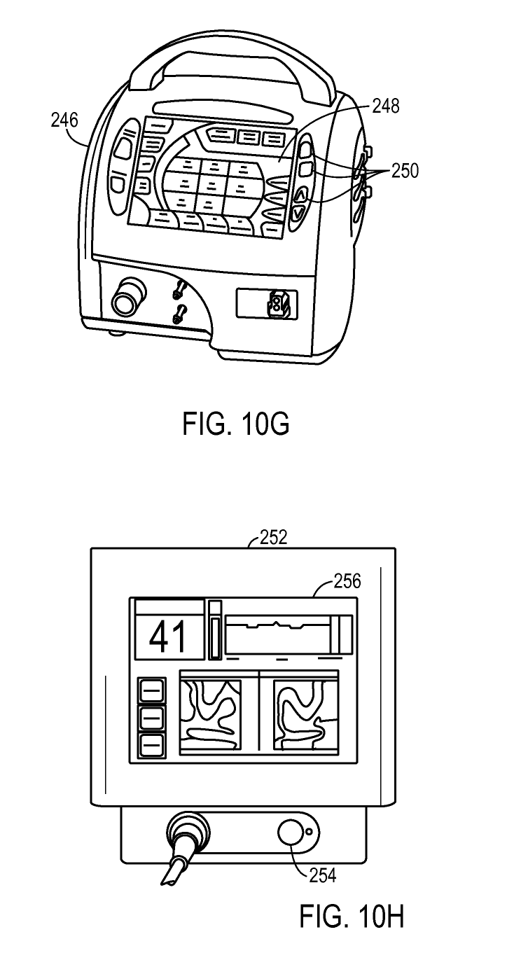

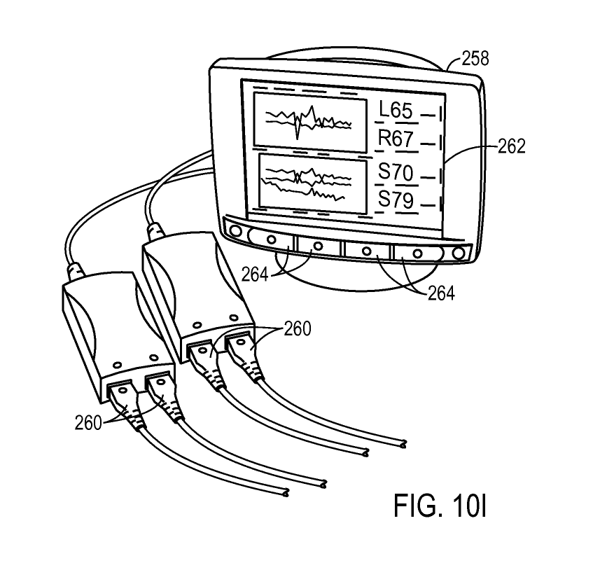

As discussed above, the product demonstration system 10 may simulate various types of products. Thus, FIGS. 10A-10I illustrate examples of additional products that of the system 10 may demonstrate, according to an embodiment. Shown in FIG. 10A is a simplified model of a bedside patient monitoring product 210 with a sensor port 212 and a display 214 on the front of the product. This product 210 lacks a touchscreen input device and instead employs a dial 216 and some external keys 218 for navigation and control of the display 214 and system functions. In simulating this product 210, the demonstration system 10 may replicate the functions of the dial 216 and keys 218 to simulate the use of the device. Utilizing the user interface 14 of the handheld device 12 the user may manipulate the rendering of the dial 216 and keys 218. The product rendering may then respond to the user manipulation and demonstrate the various functions of the product. Illustrated in FIG. 10B is another simplified model of a bedside patient monitoring product 220. This product 220 has a sensor port 222, navigation keys 224 and display 226. The model 220 has a less adaptable display 226 that may only show a waveform on a designated area of the display 226 and also lacks touch screen capability. The demonstration system 10 may render the display 226 and navigation keys 224 and allow the navigation keys 224 to be manipulated, replicating the functions of this model 220. FIG. 10C illustrates another product 228 that may be simulated using the demonstration system 10. This product is a handheld patient monitoring product 228 and includes a sensor port 230, navigation keys 232, and multiple display windows 234. The various display windows 224 each show a designated type of data. Like the simulation of the previous model, the product demonstration system 10 may simulate the functions of the navigation buttons 232 and allow a user of the demonstration system 10 manipulate them. A product rendering would then respond and demonstrate the functions of the various display windows 234 and navigation keys 232.

Also illustrated in FIGS. 10D-10F are various sensors that the product demonstration system 10 may demonstrate. Attaching the sensor 234 to the external processing module via the cable 326 may demonstrate the functionality of the adhesive disposable sensor 234 of FIG. 10D. A reusable sensor 238 illustrated in FIG. 10E may also be attached to the external processing module for demonstration via its cable 240. Another variety of non-adhesive sensor 242 is shown in FIG. 10F. This sensor may similarly be connected to the external processing module, but it suitable for use with an infant and has a different method of attachment to the patient. As discussed above, during the function of the product demonstration system 10 the various sensors may actually function to detect physiological parameters of a patient or may contain memory with simulated data that the external processing module 18 accesses. As in the case with an infant sensor 242, it may not be feasible to have a demonstration subject available, so simulated or sample data may be preferred for demonstration of this sensor 242. Alternatively, the sensor 242 may itself contain the hardware of the processing module 18. Additionally, each sensor may contain wireless transmitters to wirelessly communicate and transmit data to the external processing module 18 or to the handheld device 12. Because the product demonstration system 10 may accommodate various sensors, it allows the potential user to understand the extent of the available options of the monitoring products being demonstrated. Some products may be suitable for use with a greater variety of sensors, and some may be limited to a certain subset of sensors. Some products may respond differently when linked with different sensors. For example some sensors may detect physiological parameters more precisely. The product demonstration system 10 may simulate the various capabilities of each sensor as well as how each monitoring device may respond differently when being combined with different sensors. For example, some sensors may have different calibration processes, and trigger different dialogues when connected. Additionally, different sensors may have different accuracies, therefore resulting in data and waveforms may vary in precision or appearance. These variations may be reflected in the behavior of the product demonstration system 10.

Shown in FIG. 10G is a ventilation product 246 with a display 248 and navigation keys 250. FIG. 10H illustrates another monitoring product 252 with a single touchscreen 256 for navigation and control and sensor input 254. Though these products 246, 252 monitor and control different types of patient physiology than those previously discussed, the product demonstration system 10 may nevertheless demonstrate their capabilities. The virtual demonstration of these products 246, 252, may be substantially similar to the simulations of the above patient monitoring products 210, 220, 228. For instance, the system 10 may demonstrate use of a variety of sensor types. Additionally, the navigation of the alarms and various menus may be simulated, as well as alarms, and interaction with various physical components such as power cords and external modules. Also pictured in FIG. 10I is an additional patient monitoring product 258 including multiple sensors 260, a touchscreen 262 and separate navigation keys 264. This product receives input from multiple sensors 260. The product demonstration system 10 may also simulate interaction with the keys 264 and touchscreen 262. It is contemplated that the product demonstration system 10 may demonstrate a wide variety of products including but not limited to consumer and industrial electronics, appliances, and software. Salespersons using the system 10 may benefit from not having to transport and present actual physical products. Also, the product demonstration system 10 provides the ability to easily compare various models or varieties of products. The product demonstration system may have the capability to quickly switch from a rendering of one product to another product. A salesperson may use this capability to quickly demonstrate the manufacturer's entire line of products, and to easily highlight the differences in operation between products. Further, simulations of competitor's products may be used for comparison of features of products.

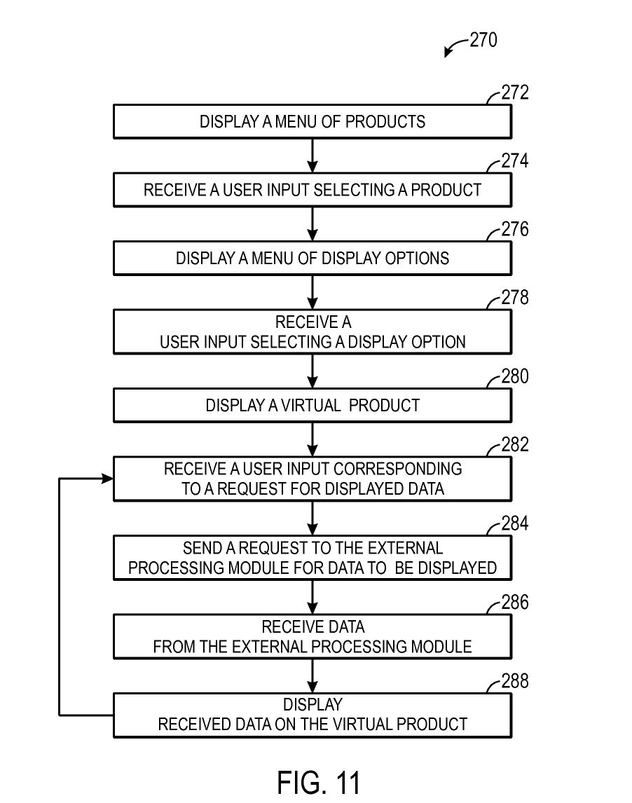

The product demonstration system 10 may operate by performing specific processes in response to user inputs, such as those included in the method illustrated by FIG. 11. As discussed in reference to FIG. 3 the product demonstration system may include a handheld device 12 in connection with an external processing module 18. For operation of the system 10, the handheld device may be configured to display a menu screen 90 listing a choice of products available to be demonstrated, as described above in reference to FIG. 4 (block 272). The handheld device 12 may receive a user input (e.g., from a potential customer, or from a salesperson demonstrating products) selecting a product from the displayed menu (block 274). As discussed above, there may be several levels of submenus used to organize all the available products that a product demonstration system 10 may demonstrate. When the lowest level menu screen 90 is displayed, and a user input selecting the desired product to be demonstrated is received, another menu 110 specific to that product may be displayed on the device 12 (block 276). The menu 110, as discussed above in reference to FIG. 5, may display the various display options for the product, such as a static option 120, dynamic option 122, and an interactive option 124. A user input may be received selecting one of the display options (block 278). If the interactive display option 124 is chosen, then the handheld device 12 may display the virtual product rendering (block 280). Some input may be received from the user (block 282), such as the user interacting with the virtual power key 138 to power on the virtual product. The handheld device 12 may then send a request to the external processing module 18 for data to be displayed on the virtual GUI 140 of the rendered product (block 284). This request may be sent via the wired interface 56 or wirelessly using the wireless interface 58 of the handheld device 12. As discussed above in regards to FIG. 3, the data may be real-time data based on the processing of a signals received from an attached sensor 20, or may be simulated or sample data stored on the memory 68 of the external processing module 18, on the memory of the handheld device 12, or on the memory 78 of the sensor 20. Regardless of the source of the data, the external processing module 18 may receive the request from the handheld device 12 and may transmit the requested data to the handheld device 12 in response. The transmission may be made via the wired interface 72 or by wireless transmissions 62 using the wireless interface 70 of the external processing module 18. The handheld device 12 may receive the requested data from the external processing module 18 (block 286). The handheld device then may process the data and display it on the virtual product rendering (block 288). The system then may receive additional user input which requires data from the external processing module (block 282). For example, a user may indicate that an additional trend view should be displayed. The handheld device may then again make a request for data to the external processing module (block 284). The external processing module may then again sends the requested data to the handheld device 12 (block 286). The handheld device 12 may then again use the data to display the appropriate visualization on the product rendering 16 (block 288). As discussed above, in some embodiments an external processing module 18 may not be included as part of the product demonstration system 10 (e.g., for systems where the handheld device processor 50 contains adequate processing resources). When no external processing module is included, the methods discussed here will omit communication with an external processing module. Therefore, any requests for data may be received directly by the handheld device processor 50. Additionally, the handheld device processor 50 will provide any data to be displayed in order to simulate the function of the product 130 being demonstrated.

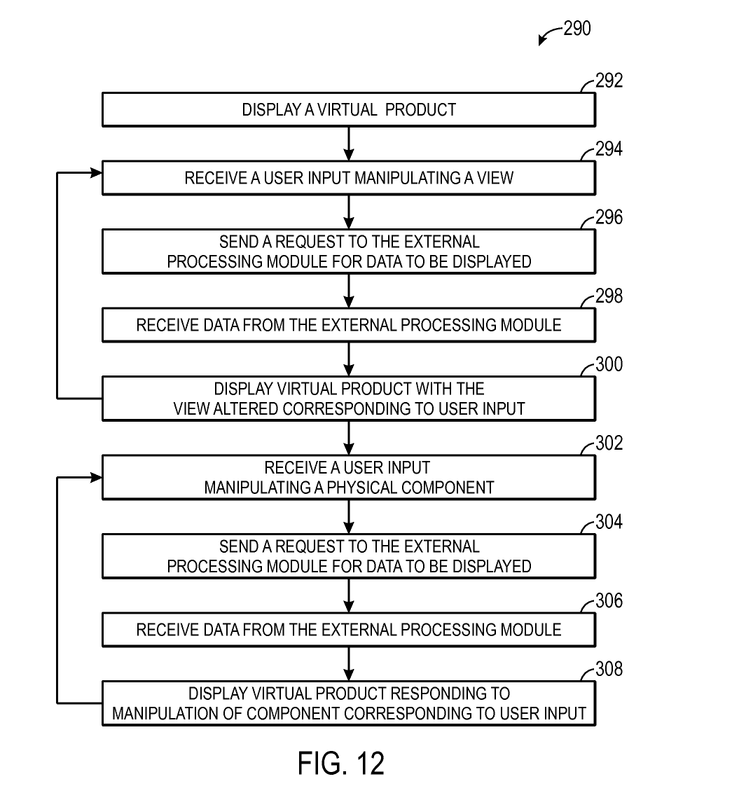

The product demonstration system 10 may operate in the manner illustrated by FIG. 12 in response to user input indicating manipulation of a view of a product rendering 16 or manipulation of a component of a product rendering 16. As discussed above, a virtual product may be displayed (block 290) on the display 14 of the handheld device 12. The handheld device 12 may then receive some user input via the user interface touchscreen 14 corresponding to manipulating the view of the product. For example, the user may indicate that the product should be rotated about a vertical axis 162, or may indicate that details of the product should be enlarged. The handheld device 12 may then send a request for any data needed from the external processing module 18 in order to complete the request (block 296). Communication between the handheld device 12 and external processing module 18 may be done via their respective wired 72 or wireless interfaces, as discussed above. A request for additional data may be made if, for example, advanced processing or data is necessary. For example, the external processing module 18 may contain the necessary processing hardware 66, code, instructions, and memory 68 to create certain advanced renderings of the product. The handheld device 12 may then receive from the external processing module 18 the necessary data needed to complete the request (block 298). The handheld device 12 may then display the virtual product with the view altered in a way corresponding to the user input (block 300). If user input is received indicating another manipulation in the view (block 294) of the product the process may repeat as the handheld device 12 may send (block 296), receive (block 298) and display (block 300) the appropriate data representing an altered view of the product. The handheld device 12 may receive user input indicating manipulation of a physical component of the simulated product (block 302). The handheld device 12 may then send a request for any data needed from the external processing module 18 in order to complete the request (block 304). The handheld device 12 may then receive from the external processing module 18 the necessary data needed to complete the request (block 306). For example, the user input may indicate that an alarm on the product is activated. The external processing module 18 may then trigger a routine that simulates operation of the alarm on the simulated product and send the appropriate data to the handheld device 12. The handheld device 12 may then display the virtual product acting appropriately in response to the manipulation of the component that the user input indicates (block 308). If user input is received indicating another manipulation of a physical component (block 302) of the product the process may repeat as the handheld device 12 sends (block 304), receives (block 306) and displays (block 308) the appropriate data representing an simulated response of the product. As discussed above, in some embodiments the product demonstration system may not include a external processing module 18 and any processing may be carried out on the processor 50 of the handheld device 12. Additionally, in some embodiments, the system 10 may include an external processing module, but certain aspects of the product simulation may be conducted on the handheld device. For instance, the processing involved to display animation of a product rendering 16 may be able to be performed by the handheld device processor 50, but more complex requests, such as the display of a waveform, may be directed to the external processing module 18.

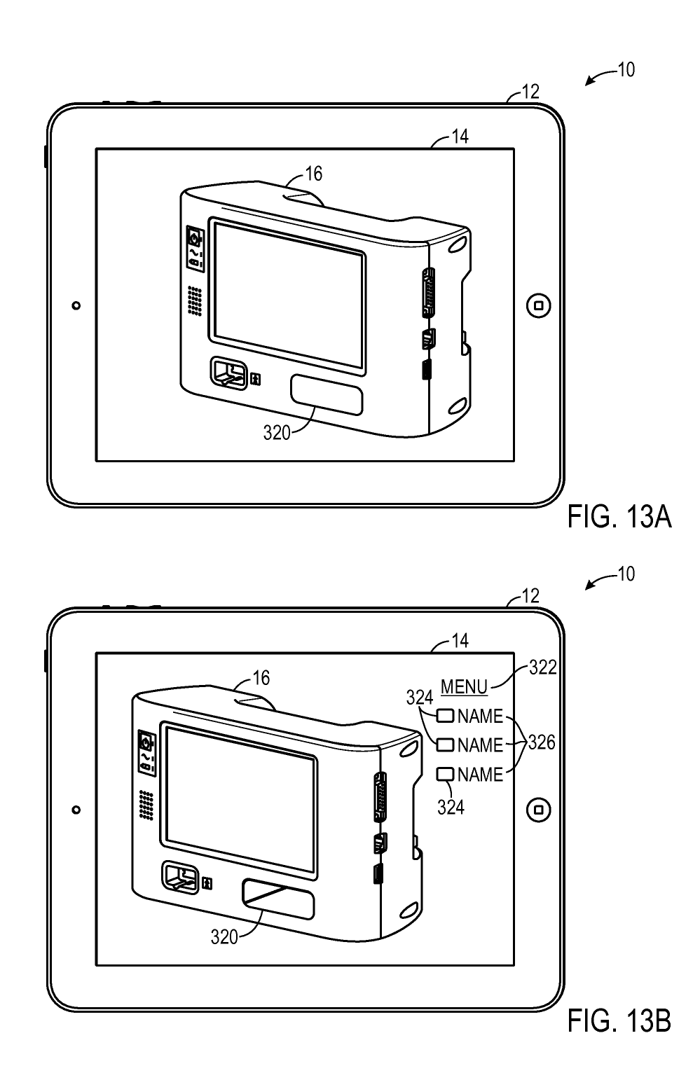

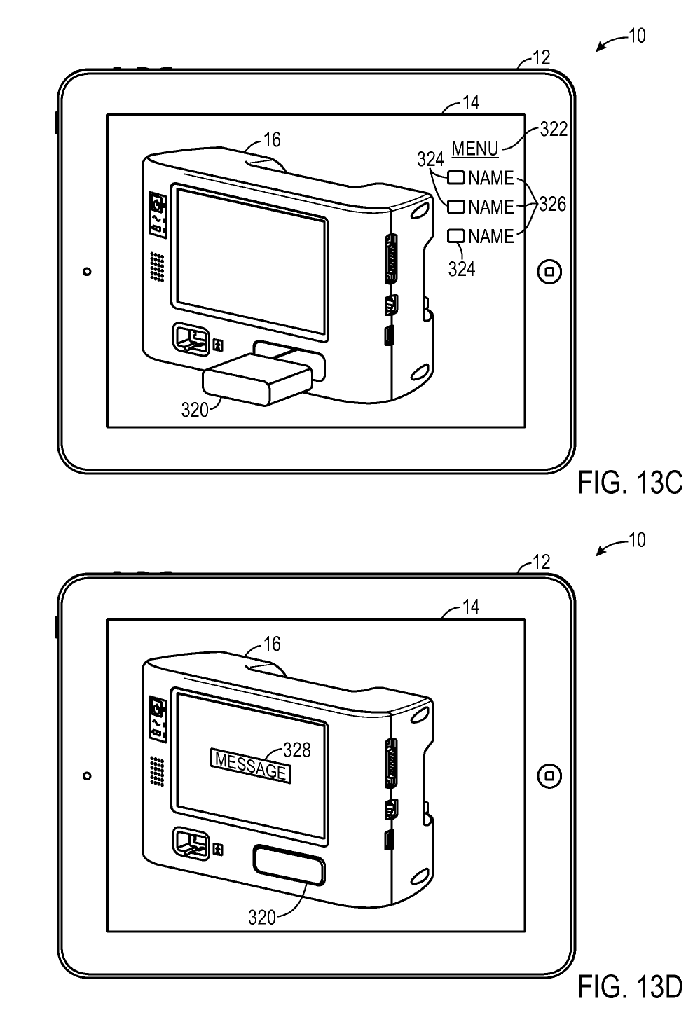

As an example of the above method, FIGS. 13A-13D illustrate steps in a method of operating the product demonstration system 10 in which user input manipulate a component of a simulated product 16. FIG. 13A shows the handheld device 10 of the product demonstration system 10 displaying a perspective view of an interactive rendering 16 of a monitoring device 130 having an interactive component 320, in this case a modular hardware site. This modular hardware site 320 allows a user of a monitoring device 120 to insert specialized hardware modules that allow the device 130 to perform specialized applications (e.g., determine specific physiological parameters such as SpO₂). A user of the product demonstration system 10 may interact with the rendering 16 of the monitoring device 130 and the response of the system 10 may allow the user to observe the functionality of this component 320. Specifically, a prospective customer may select the rendering at the location of a component 320 (e.g., by making prolonged contact with the touchscreen display 12 at the location of the component 320). This manipulation may result in a response from the product demonstration system 10 such as a demonstration of the function of the component 320 or dialogue box prompting the user to provide additional user input. As illustrated in FIG. 13B, a menu 322 may appear that gives the user options of how to interact with the component 320 they have selected or manipulated. In the present example, when a user selects the modular hardware site 320, a menu 322 may appear displaying component options images 324 with corresponding titles 326. In this case, the options 324 represent possible modular hardware components that may be inserted at the modular hardware site 320. FIG. 13C illustrates how one of the modular hardware component option images 324 may be selected and virtually inserted into the simulated modular hardware site 320 (e.g., by selecting and dragging the image of the component option 324 from the menu 322 to the location of the component site 320). FIG. 13D shows how the interactive product rendering 16 may respond after the component 320 has been manipulated. The appearance of the component 320 may be altered after the user manipulation. For example, to indicate that optional hardware 324 has been virtually inserted into the module site 320, the optional hardware may be visible on the product rendering 16. Additionally, the insertion of a hardware module 324 may trigger simulations of how the actual product would behave in response to the inserted hardware. For example, a simulated dialogue box 328 indicating that new hardware 324 has been detected by the monitoring device 130 may appear on the simulated graphical user interface 140 of the product rendering 16. The user of the demonstration system 10 may then further interact with the product rendering 16 to simulate any additional functions now available, such as displaying an additional type of waveform or an additional physiological measurement.

The product demonstration system 10 has been discussed as a marketing device to be used as salespeople in the course of the sales cycle, but it is contemplated that the demonstration system may be used for other purposes. For example, the system 10 may be used to train users on the operation products or to train technicians on the maintenance and repair of products. Further, the system 10 may be used in educational or simulation settings where only a subset of the complete capabilities of products are needed, or for any other suitable purpose.

What is claimed is:

1. A product demonstration system, comprising:
a handheld device, comprising:
a display for displaying one or more products available from a supplier of the products; and
a processor configured to receive a user input to manipulate at least one product of the products, wherein the handheld device is configured to enable a user to simulate interaction with the at least one product.

2. The product demonstration system of claim 1, wherein the user input manipulates a view of the at least one product, and the display is configured to alter the view of the at least one product in response to the user input.

3. The product demonstration system of claim 1, wherein the user input manipulates physical components of the at least one product, and the display is configured to display the manipulation of the physical component.

4. The product demonstration system of claim 1, wherein the user input requests acquiring physiological data from the user, and the display is configured to display the physiological data.

5. The product demonstration system of claim 4, comprising a processing module separate from the handheld device, communicatively coupled to the handheld device, and configured to provide the physiological data to the handheld device upon receiving a request based on the user input from the handheld device.

6. The product demonstration system of claim 5, wherein the processing module is communicatively coupled to the handheld device via a wireless interface.

7. The product demonstration system of claim 5, wherein the processing module is communicatively coupled to the handheld device via a wired interface.

8. The product demonstration system of claim 5, wherein the physiological data is simulated physiological data.

9. The product demonstration system of claim 5, comprising a sensor operatively coupled to the processing module and configured to acquire a signal representative of physiological data, wherein the processing module is configured to process the signal and to provide actual physiological data as acquired from the user via the sensor to the handheld device, and the display is configured to display the actual physiological data.

10. The product demonstration system of claim 9, wherein the sensor comprises a pulse oximetry sensor.

11. The product demonstration system of claim 1, wherein the products comprise one or more monitoring devices, sensors, accessories, or a combination thereof.

12. The product demonstration system of claim 1, wherein the display comprises a touchscreen configured to receive the user input.

13. The product demonstration system of claim 1, wherein handheld device comprises a smart phone, a tablet computer, or laptop.

14. A product demonstration system, comprising:
a sensor configured to generate a signal representative of physiological data;
a processing module operatively coupled to the sensor and configured to receive and to process the signal to generate the physiological data;
a handheld device communicatively coupled to the processing module, comprising:
a display for displaying at least one monitoring device; and
a processor configured to receive a user input to acquire physiological data from a user coupled to the sensor, to request the physiological data of the user from the processing module as the physiological data is acquired, and to display the physiological data on the display.

15. A method for interfacing with a product demonstration system, comprising:
displaying a plurality of products available from a supplier of the products on a display of a handheld device;
receiving a first user input selecting at least one product from the plurality of products;
displaying the at least one product on the display;
receiving a second user input to manipulate the at least one product; and
simulating on the display user interaction with the at least one product in response to the user input.

16. The method of claim 15, wherein receiving the second user input comprises simulating movement of components of the at last one product.

17. The method of claim 15, wherein receiving the second user input comprises simulating activating the at least one product to acquire physiological data.

18. The method of claim 17, comprising requesting physiological data from a processing module separate from and communicatively coupled to the handheld device.

19. The method of claim 18, comprising the handheld device receiving simulated physiological data from the processing module.

20. The method claim 18, comprising the handheld device receiving actual physiological data from the processing module acquired from a user of the handheld device coupled to a sensor, the sensor being operatively coupled to the processing module, and displaying the actual physiological data on the display as the actual physiological data is acquired from the user.
